(19) United States
(12) Patent Application Publication
(10) Pub. No.: US 2026/0274572 A1
(43) Pub. Date: Sep. 17, 2026

(54) STORAGE BOX MANIPULATOR FOR SWIMMING POOLS, INDOOR POOLS, OUTDOOR POOLS, FITNESS STUDIOS, AND CHANGING AREAS OF INDUSTRIAL COMPANIES

(71) Applicant: DELTA-X GMBH INGENIEURGESELLSCHAFT, Stuttgart (DE)

(72) Inventors: Dr. Albrecht Burmeister, Welssach im Tal (DE); Walter Klas, Neukirch (DE)

(21) Appl. No.: 19/469,600

(22) PCT Filed: Feb. 26, 2024
(86) PCT No.: PCT/EP2024/054829

§ 371 Date: Sep. 26, 2025

(30) Foreign Application Priority Data
Mar. 4, 2023 (DE) 10 2023 108 475.5

(51) Int. Cl. B65G 1/04; B25J 5/00; B25J 5/02; B25J 13/08; B25J 15/06

(52) U.S. Cl. CPC B65G 1/0485; B25J 5/007; B25J 5/02; B25J 13/084; B25J 15/0608

(57) ABSTRACT

A storage box manipulator includes an effector detachably connectable to an interface of a storage box. The effector comprises at least two switchable magnetic holding elements having holding regions that together span a holding surface. The interface of the storage box provides a ferromagnetic counter surface shaped complementarily to the holding surface. The holding surface of the effector and the counter surface of the storage box are flat, enabling stable magnetic attachment and detachment of the storage box for handling and manipulation.

The invention relates to the changing areas of spas, public swimming pools (outdoor or indoor pools), commercial fitness studios, but also to the changing areas of industrial plants where workers change their clothes before starting work, exchanging their street clothes for their work clothes.

For many decades, a system has been established in such changing areas that is very static, offers little convenience and requires a lot of space: There are changing cubicles in which the user changes. The user takes off their street clothes and puts on, for example, swimming trunks, a swimsuit, sportswear or workwear. The stored street clothes are hung on a hanger and locked in a locker. The locker is not located in the changing cubicle, but at another location. The user takes the key to this locker along with them.

When the user wants to leave the spa or the workplace, he first goes to the locker and takes the hanger out of it with the clothes hanging on it. With the hanger in his hand, he goes into a free changing cubicle and changes there. This system is not very user-friendly, because the user has to go to two places every time they want to change: the changing cubicle and the place where the lockers are located.

In large changing areas, this leads to many users moving around in the corridors and hallways between the changing cubicles and lockers. This “pedestrian traffic” requires wide aisles and corridors. That is, the space requirement is considerable. However, it also increases the number of contacts between users. These contacts are undesirable because they contribute to the transmission of infections, whether it be colds, flu, or the coronavirus.

From JP H07 107718 B2, a changing area with a plurality of changing cubicles is known, which comprises a plurality of changing cubicles. “Behind” an exterior wall of the changing cubicles is a high-rack storage facility with a plurality of storage areas for storage boxes. An intermediate region is provided between the high-rack storage facility and the changing cubicles.

A storage box is transported from a changing cubicle to a free storage area in the high-rack storage facility via a conveyor belt in the intermediate region and a stacker crane in the high-rack storage facility. The transport of a storage box between a storage area in the high-rack storage facility and a changing cubicle requires the use of the stacker crane and a conveyor belt. The system known from JP H07 107718 B2 requires a lot of space. It is also very complex and comparatively expensive.

The invention is based on the object of providing a device which makes the transport of storage boxes between a changing cubicle and a storage area in the high-rack storage facility simpler, more space-saving and more economical.

This object is achieved according to the invention by a storage box manipulator comprising an effector, wherein the effector is detachably connectable to an interface of a storage box.

The storage box manipulator according to the invention is also referred to as a manipulator for storage boxes.

The effector according to the invention makes it possible to detachably connect a storage box to the storage box manipulator. In this state, the storage box can be removed from a changing cubicle and moved to a free storage area. It is also possible to transport a storage box that is located in a storage area to any changing cubicle.

Industrial robots, e. g., articulated arm robots, can be used as storage box manipulators. In a preferred embodiment of the invention, the detachable connection between the effector of the manipulator and the storage box is made by means of switchable magnetic holding elements. This means that the effector comprises at least one, but preferably two or more switchable magnetic holding elements, the holding regions of which span a holding surface of the effector. The at least one interface of the storage boxes is a ferromagnetic counter surface that is/are shaped complementarily to the holding surface of the effector. This makes it possible to bring the holding regions of the magnetic holding element(s) into contact with the ferromagnetic counter surface of the storage boxes. In this state, it is possible to activate the switchable magnetic holding elements. They then exert a magnetic force on the ferromagnetic counter surface and establish a connection between the storage box and the effector of the storage box manipulator. As long as the connection exists, the storage box can be moved to a desired destination with the assistance of the storage box manipulator.

The connection can be released by appropriately controlling the magnetic holding element(s). It is released whenever the storage box is located at the desired destination. The desired destination can be a changing cubicle. But it can also be a storage area in a rack system or another storage system. This depends on whether the storage box is to be “temporarily stored” in a storage facility, or whether the user of a changing cubicle wants to have “his storage box” in the changing cubicle. The user can then fill it with his items of clothing, etc. before visiting the spa. After visiting the spa or the rest of the facility, he can remove the items of clothing that are in the storage box and put them back on.

It is preferred if the effector has two or even more magnetic holding elements. Larger holding forces can then be transmitted, and this results in a redundancy of the holding elements. This increases the security of the system.

By cleverly arranging the holding elements, in particular by maintaining a large distance between the holding elements, the force that can be transmitted between the effector and the storage box or its counter surface is increased-all other conditions being equal.

To give an example: If the holding elements are arranged at a distance of, for example, 30 cm from each other, then the forces arising during pivoting movements or due to tipping moments between the storage box and the effector can be transmitted better than if the distance is only 10 cm.

It is particularly simple and also very effective if the holding surface of the effector and at least one counter surface of a storage box are flat. This makes production easier.

However, it can also be useful if the holding surface of the effector and the at least one counter surface are not designed as a flat surface, but have, for example, depressions or projections. This allows a form-fit connection to be realized in addition to the magnetic connection.

It is particularly advantageous if the counter surface of the storage box is significantly larger than the holding surface spanned by the holding regions of the magnetic holding elements. For example, if the counter surface is twice as large as the holding surface spanned by the holding regions, then two effectors can be connected to a counter surface of a storage box at the same time. In this way, a storage box that is held by a first storage box manipulator can be transferred to a second storage box manipulator or another transport device that is equipped with an effector according to the invention.

The transfer takes place by bringing the effector of the second storage box manipulator into contact with a free region of the counter surface of the storage box. Then this second effector is activated. Once this connection is established, the effector of the first storage box manipulator can be switched off and the first manipulator can move away from the storage box. The now active second storage box manipulator can then either bring the storage box directly to the desired destination or transfer it to a third storage box manipulator.

It is also possible for two or more counter surfaces to be arranged on a storage box. The counter surfaces are preferably arranged in different regions/on different outer surfaces of the storage boxes.

Even then, it is possible to transfer the storage box from a first storage box manipulator to another or a plurality of other storage box manipulators. An additional advantage is that the effectors can be guided to the counter surfaces from different directions if they are arranged on different outer surfaces of the storage boxes.

In order to ensure the safe operation of the manipulator and to detect a secure connection between the effector and the storage box, it is advantageous if the storage box manipulator comprises contact detection means for detecting a contact between the holding surface of the effector and an interface or a ferromagnetic counter surface of a storage box.

If the contact detection means detect contact between the holding surface of the effector and the counter surface of a storage box, then a secure connection between the effector and the storage box is ensured. The movement controller of the storage box manipulator can then be unlocked or activated, and the storage box manipulator can remove the storage box from its current “safe” location, for example, on a rack in the region of the changing cubicle or from a storage area.

If a faulty connection between the effector and the storage box is not detected, the storage box would fall down as soon as it leaves the storage area or the rack in the region of the changing cubicle. This can be effectively prevented by the contact detection means according to the invention and the evaluation of their output signals in the controller of the manipulator.

The contact detection means can be implemented in the form of at least one spring-loaded contact pin. If the spring-loaded contact pin(s) protrude beyond the holding surface of the effector, then there is no contact between the holding surface and a counter surface of a storage box. When the counter surface of a storage box rests against the holding surfaces, it pushes the contact pin back against the force of the spring until its end lies in the holding surface.

If the end(s) of the spring-loaded contact pin(s) lie in the holding surface, then this is because the counter surface of the storage box has moved the spring-loaded contact pins so far against the spring force of the contact pins that the ends of the contact pins are located in the holding surface. This position of the contact pins can be determined using simple electrical switching elements (buttons). The status messages provided by the contact pin(s) (“Contact pin protrudes beyond the holding surface” or “End of the contact pin lies in the holding surface”) can be evaluated in a controller of the storage box manipulator. For example, a release can be given to the controller of the storage box manipulator.

It is also possible to carry out an electrical contact check instead of or in addition to the position of the contact pins for the evaluation or detection of a connection between the effector and the counter surface.

This takes advantage of the fact that the counter surface consists of a ferromagnetic and therefore electrically conductive material. Therefore, if an electrical voltage is applied between two contact pins and the ends of these spring-loaded contact pins touch the counter surface, then a current flows between these contact pins. By measuring the current, it can be detected whether or not there is electrical contact between the contact pins and the counter surface. If this electrical contact is made, the counter surface is in the desired position and the magnetic locking can take place. If no current flows, the distance between the counter surface and the holding elements of the effector is then too large so that secure locking is not possible.

For safety reasons, it is preferred if each of the magnetic holding elements comprises one or more permanent magnets and at least one electromagnet. When the electromagnet is energized, the magnetic forces exerted by the permanent magnet(s) and the at least one electromagnet on the ferromagnetic counter surface of a storage box cancel each other out by at least 60%.

In other words: When the magnetic holding elements are de-energized, 100% of the magnetic forces exerted by the permanent magnet(s) hold the counter surface and with it the storage box in contact with the effector. The magnetic lock or connection is therefore active.

As soon as at least one electromagnet is energized, the magnetic forces acting on the opposing surface decrease.

The connection between the storage box and the effector is thus broken. It is not necessary for the magnetic forces exerted by the permanent magnets and the electromagnets to cancel each other out 100%. It is sufficient if the forces largely cancel each other out to break the connection.

The manipulator can be an articulated arm robot or another type of industrial robot. It is advantageous if the manipulator is movable so that it can reach a plurality of changing cubicles even if the working region of the manipulator is smaller than the spatial distance between the changing cubicles or storage areas to be reached.

The manipulator can be moved on rails or on wheels. If the manipulator can be moved on wheels across a hall floor, it is then particularly advantageous if induction cables are run in the hall floor so that the manipulator can be moved in the room via an inductive controller. Such inductive controls are known from the field of production technology. With their help, for example, in industrial halls, transport trolleys that are loaded with components to be assembled are moved from an output point in a high-rack storage facility to a workplace of a worker. The induction cables are arranged in the hall floor invisibly and protected from damage.

Of course, other guides are also possible, such as a combination of a linear guide and a drive by means of a rack and pinion that is driven by an electric motor.

Further advantages and advantageous embodiments of the invention can be seen in the following drawing, its description and the claims.

### DRAWINGS

In the drawings:

FIG. 1 shows a (partial) embodiment of a manipulator according to the invention;

FIG. 2 to 5 show details of an interface of an effector according to the invention;

FIG. 6 shows another embodiment of a manipulator according to the invention;

FIG. 7 to 9 show the integration of the manipulator into a changing area a with rack storage facility.

### DESCRIPTION OF THE EXEMPLARY EMBODIMENTS

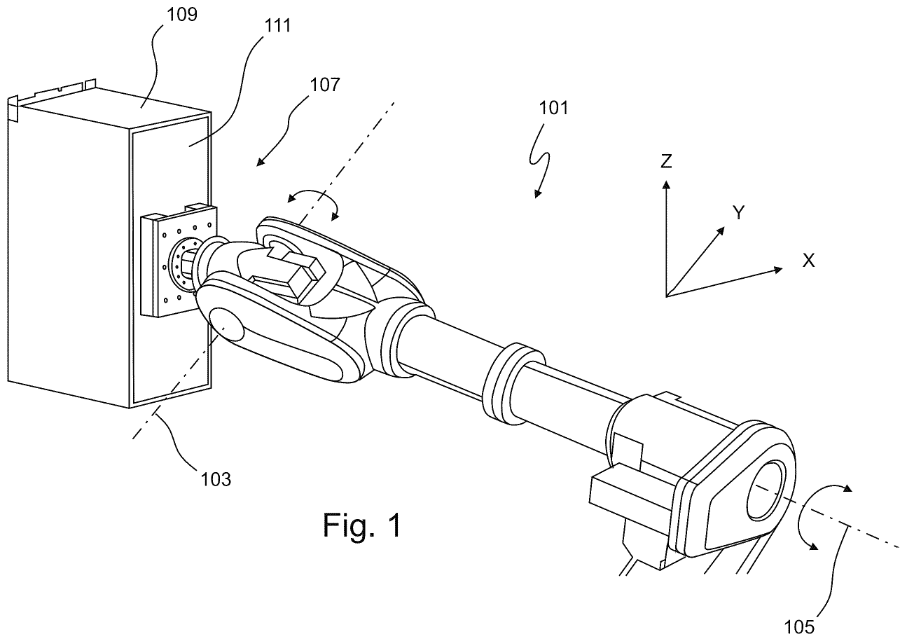

FIG. 1 shows an embodiment of a storage box manipulator 101 according to the invention. In this embodiment, the storage box manipulator 101 (hereinafter referred to as a manipulator) is an articulated arm robot known from automation technology, which has a plurality of axes of movement.

The lower part or the rear end of the articulated-arm robot is not shown in FIG. 1 since the invention does not relate to the structural design of the articulated-arm robot, and such articulated-arm robots are known to a person skilled in the art.

In FIG. 1, three linear axes of movement in three spatial directions are indicated by a coordinate system with the coordinate axes “X” “Y” and “Z.” Two axes of rotation 103 and 105 are also indicated. The manipulator does not necessarily have to have three linear motion axes and two rotation axes 103 and 105.

With the aid of these axes of movement, an effector 107 which is fastened to the manipulator 101, and with it a storage box 109 fastened thereto, can be removed from a storage area (not shown) and transported to another storage area or to a changing cubicle (not shown) and placed there. Of course, the reverse process is also possible, namely that with the help of the manipulator 101, a storage box 109, which is located in a changing cubicle, is brought by the manipulator 101 to a storage area intended for it.

The storage box 109 serves as a container for items of clothing and other belongings which the user of a changing cubicle wishes to put away and store safely while visiting a spa or a swimming pool, protected from access by third parties.

The storage box 109 can, for example, be designed as a cuboid-shaped housing with a lid that can be opened and closed by the user. The storage box 109 has a counter surface 111 made of a ferromagnetic material.

The counter surface 111 can, for example, be a steel sheet. It can be designed as a flat sheet, as shown here. However, it is also possible to design the counter surface 111 as an angled L- or U-shaped metal sheet so that it extends over two or three sides of the storage box 109.

The counter surface 111 is the interface of the storage box 109 which, together with the effector 107, enables a detachable connection between the manipulator 101 and the storage box 109.

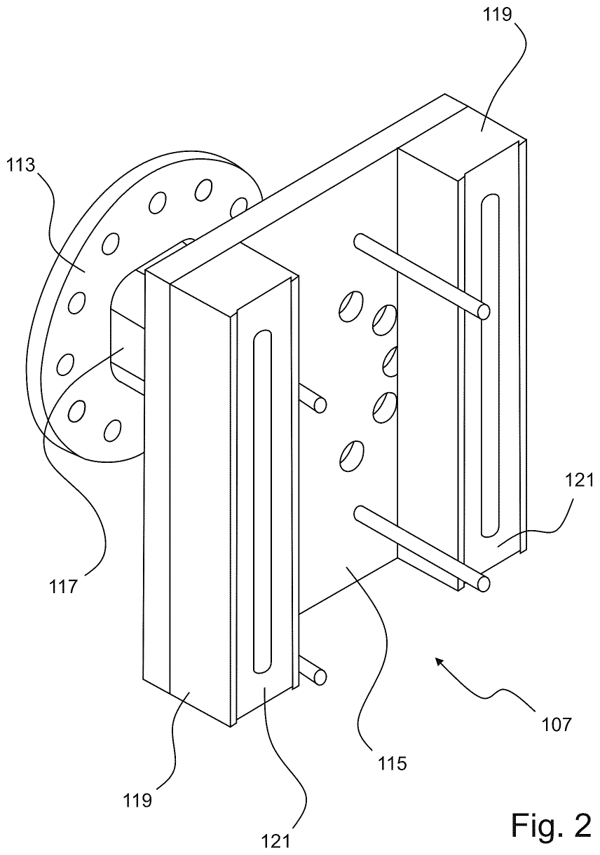

The structure and function of the effector 107 are explained in more detail below with reference to FIG. 2 to 5. The effector 107 comprises a flange plate 113. The effector 107 is screwed to the “front” end of the manipulator 101 or a commercially available articulated-arm robot or a similar industrial robot via the flange plate 113.

The flange plate 113 comprises a plurality of mounting holes (without reference signs) whose hole circle diameter is matched to the end of or interface of the manipulator 101.

Furthermore, the effector 107 comprises a plate 115. The plate 115 and the flange plate 113 are connected to each other via an optional spacer 117. The spacer 117 can be designed as a square tube.

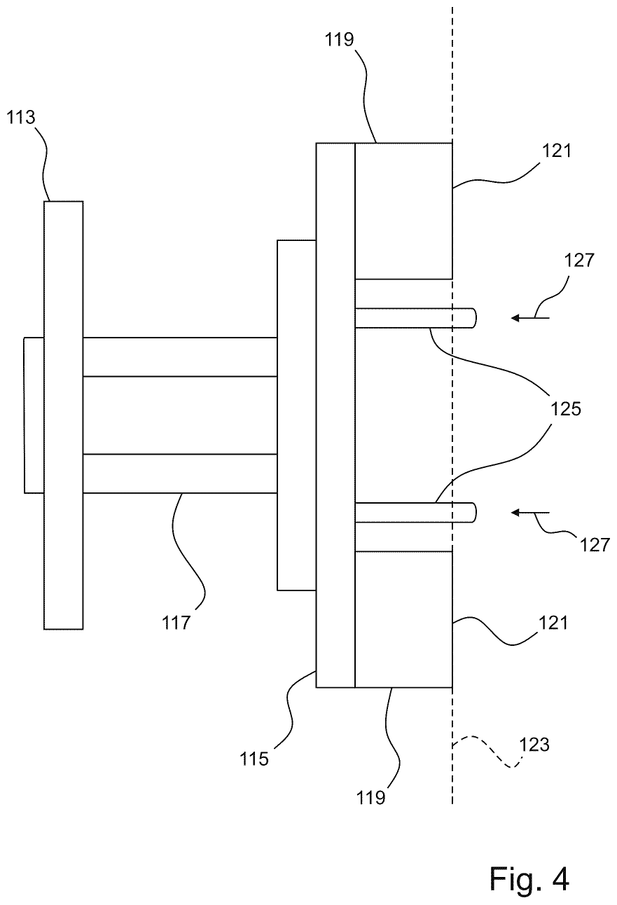

In this embodiment, two magnetic holding elements 119 are arranged on the plate 115. The magnetic holding elements 119 have holding regions 121 which, in this embodiment, lie in one plane. This plane is also called the holding surface of the effector. In this embodiment, the holding surface of the effector 107 runs parallel to the plate 115. The holding surface is identified in FIG. 4 by reference sign 123.

The effector 107 also has optional contact detection means. These contact detection means increase the operational reliability of the storage box manipulator 101 according to the invention. They detect whether the holding regions 121 of the effector 107 are in contact with the counter surface 111 of the storage box 109. A sufficiently strong connection between the manipulator 101 and storage box 109 only arises when the magnetic holding elements 119 are activated.

In this embodiment, the contact detection means are spring-loaded contact pins 125. As can be seen from FIGS. 2 and 4, the ends of the contact pins in the illustrated state protrude beyond the holding surface 123 of the effector or the holding regions 121 of the magnetic holding elements 119.

If, as can be seen in FIG. 1, the effector 107 is brought into contact with the counter surface 111 of a storage box 109, the counter surface 11 pushes the contact pins 125 back until the ends of the contact pins 125 are located in the holding surface 123 of the effector 107 (see FIG. 4).

This makes it possible to detect whether the effector 107 is in contact with the counter surface 111. The contact detection devices can be simple buttons.

The functioning of the contact pins or the contact detection means is explained in more detail below in connection with FIG. 4.

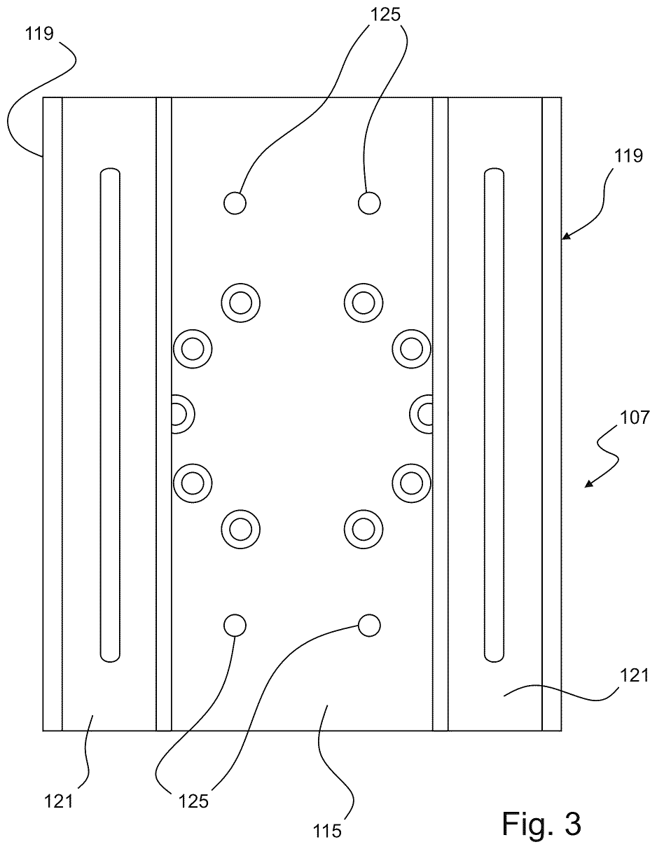

FIG. 3 is a front view of the effector 107. There are a plurality of through holes (without reference signs) in the plate 115. The through holes have the same hole pattern as the mounting holes of the flange plate 113. This makes it possible to reach the screw heads (not shown) of the fastening screws which serve to fasten the flange plate 113 to the manipulator 101.

FIG. 4 shows a side view of the effector 107. In FIG. 4, the holding surface 123 is indicated by a broken line. The holding surface 123 is spanned by the holding regions 121 of the magnetic holding elements 119.

In the embodiment shown here, the holding regions 102 of the two magnetic holding elements 119 lie in one plane. The holding surface 123 of the effector 107 lies in this plane.

It is of course also possible and conceivable that the holding regions 121 of the magnetic holding elements 119 are not arranged in one plane, but for example offset parallel to one another or even at a certain angle to one another. Then the holding surface 123 would have a step-like geometry or an angled geometry and consist of two or more sections.

In the state shown in FIG. 4 in which the effector is not in contact with a counter surface 111 of a storage box, the ends of the contact pins 125 protrude beyond the holding surface 123.

When the effector 107 comes into contact with a counter surface 111 of a storage box, the counter surface 111 then pushes the ends of the contact pins 125 back until they are located in the holding surface 123.

This movement is indicated in FIG. 4 by arrows 127. The contact pins 125 can be designed as simple buttons which are open, for example, in the position shown in FIG. 4 and close as soon as the ends of the contact pins 125 are located in the holding surface 123.

It is also possible that an electrical voltage is present between two contact pins 125. In the position shown in FIG. 4, no current would flow between the contact pins 125 (I=zero) due to the large distance between the contact pins 125. However, when the contact pins are in contact with a ferromagnetic counter surface 111, the counter surface 111 closes the circuit between the contact pins 125 with different polarity.

From the current flow (I>0) that then occurs, it can be detected that the effector 107 is in contact with a ferromagnetic counter surface 111.

Of course, other contact detection means can also be used to detect the contact between the counter surface 111 and the effector 107.

The magnetic holding elements 101 preferably function as follows:

The magnetic holding elements 101 comprise at least one permanent magnet. The permanent magnets are dimensioned so that they can support a loaded storage box 109.

In addition, each magnetic holding element 101 also comprises at least one electromagnet. When the electromagnet is energized, the magnetic forces of the permanent magnet and the electromagnet(s) largely cancel each other out so that the resulting magnetic force approaches zero. This releases the connection between the storage box 109 and the manipulator 101.

If one looks at FIG. 1, it becomes clear that the counter surface 111 is more than twice as large as the plate 115 of the effector 107 or the area spanned by the holding regions 121 of the magnetic holding elements 119.

The transfer of a storage box 109 from a first manipulator 101 to a second manipulator 101 can take place as follows:

The size of the counter surface 111 allows, for example, an effector (not shown) of a second manipulator 105 to be positioned above the (first) effector 107 shown in FIG. 1 and this second effector 107 to be activated so that the storage box 109 is held by two manipulators 101 for a short time.

Once it is ensured that the connection between the second effector 107 and the storage box is established, the first manipulator is deactivated. This releases the connection between the first manipulator and the storage box 109.

After that, only the second manipulator 109 carries the storage box 109.

It is thus possible to transfer the storage box 109 safely from one manipulator or from one effector 107 to another effector 107. This significantly expands the handling options of the manipulator 101 according to the invention and the associated storage box.

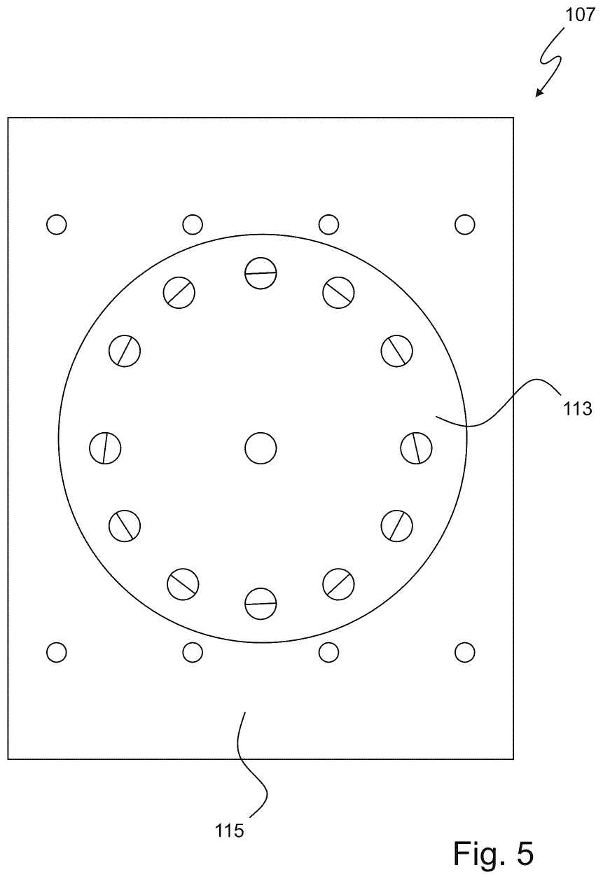

FIG. 5 shows a view from the rear of the effector 107.

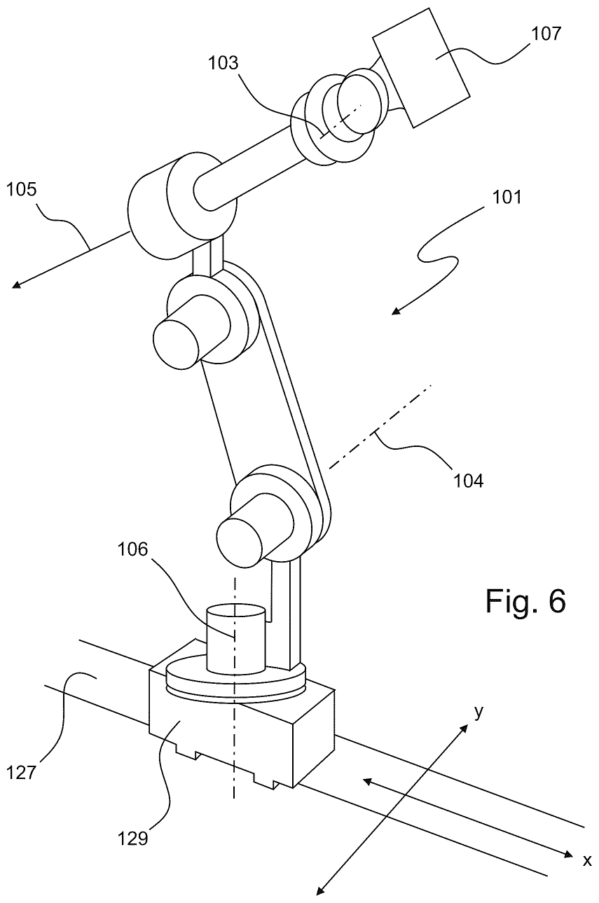

FIG. 6 shows an embodiment of a manipulator 101 according to the invention with an effector 107 shown only schematically. The manipulator 101 has four rotation axes 103, 105, 104 and 106. In addition, the manipulator 101 can be moved linearly in the direction of the X-axis.

Only indicated is a rail 127 on which a base part 129 of the manipulator 101 is movably guided. By controlling the rotary axes 103 to 106 and the linear axis in the direction of the Y-axis, the effector 107 can assume a plurality of positions and orientations within its working region. can It can therefore be moved with the holding surface of the effector 107 to the counter surfaces 111 of a storage box 109 (not shown). Subsequently, the holding elements 119 are activated, and the connection between the effector 107 and the storage box 109 is established so that the storage box can be brought to the desired location and placed there with the aid of the manipulator 101. The connection between effector 107 and storage box 109 is then released.

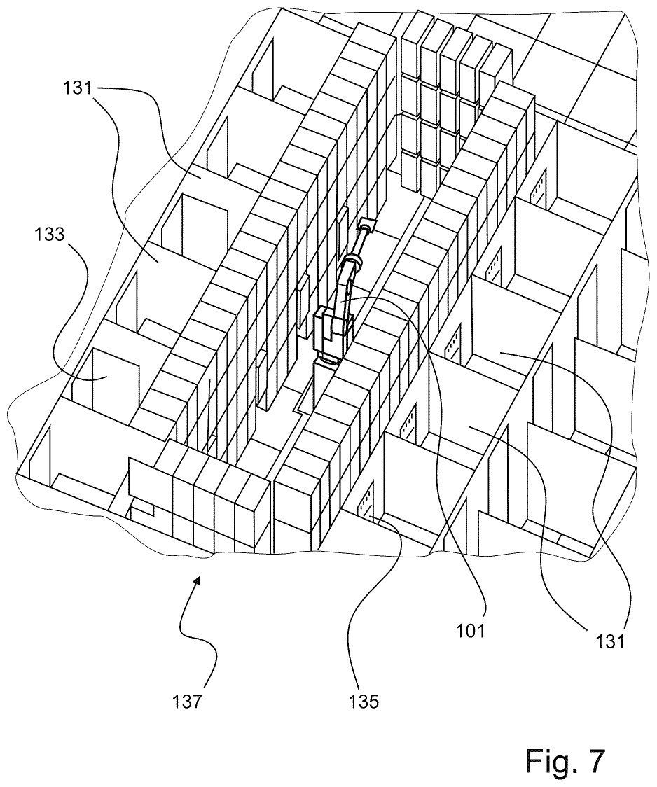

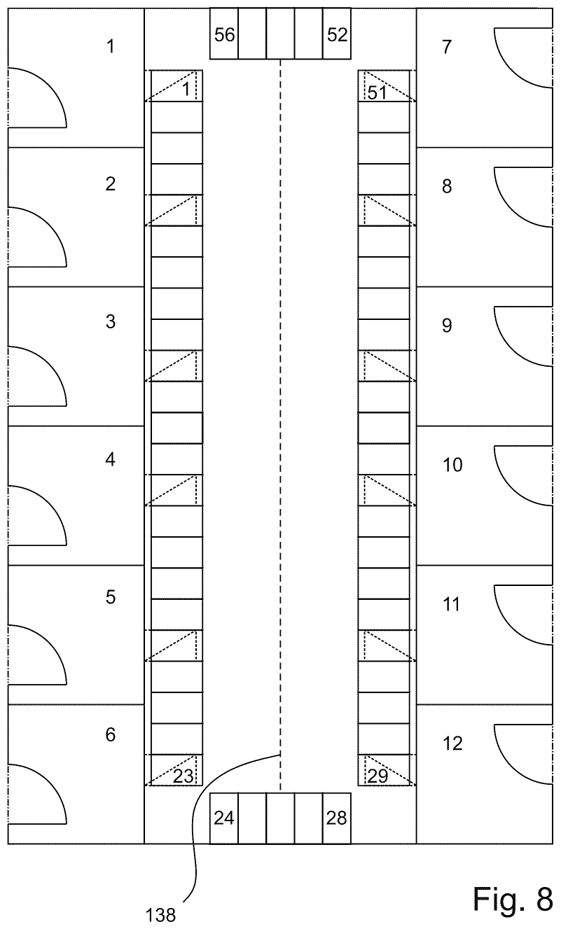

This procedure will be explained in more detail in connection with FIGS. 7 and 8. The changing cubicles have the reference sign 131. For reasons of clarity, in each case only one and only a few changing cubicles have been given the reference sign 131. In the left row of changing cubicles 131 in FIG. 7, the doors 135 and 133 are shown open. An opening 135 is cut out in the wall opposite the doors 133 (see the right row of changing cubicles 131 in FIG. 7). This opening 135 can be closed with a flap or a slider or opened when necessary. In the changing cubicle according to the invention, a rack storage facility 137 is located behind the wall with the opening 135.

The rack storage facility 137 is rectangular in a plan view from above (see FIG. 8). It comprises fifty-six storage areas on one plane. In this embodiment, the storage areas are located on both sides of the longitudinal axis 138 of a lane within which the manipulator 101 moves. These storage locations are numbered 1 to 23 and 29 to 51. In addition, further (optional) storage areas can be available at the ends of the lane. In FIG. 8, they have the numbers 24 to 28 and 52 to 56

The number of storage areas available on one plane can be adapted to requirements by adjusting the length and width of the lane. In the embodiment shown in FIG. 7, storage areas are arranged on four planes one above the other. In total, there are therefore over two hundred storage areas available for storage boxes 107 in the rack storage facility 137.

The manipulator 101 is located inside the rack storage facility 137. It can be moved in the direction of the longitudinal axis 138 (see FIG. 8). In FIG. 8, the manipulator 101 is not shown. For example, a rail 127 can be mounted on the floor of the storage facility, on which the manipulator 101 can be moved back and forth.

The manipulator 101 can reach every storage area of the rack storage facility 137. With the help of the effector 107, it can remove a storage box that is placed in one of the storage areas and connect it in the. This is done in the manner described above in connection with FIG. 1 to 5. When this connection exists, the manipulator can, for example, remove the storage box from a storage area and bring it close to a desired changing cubicle.

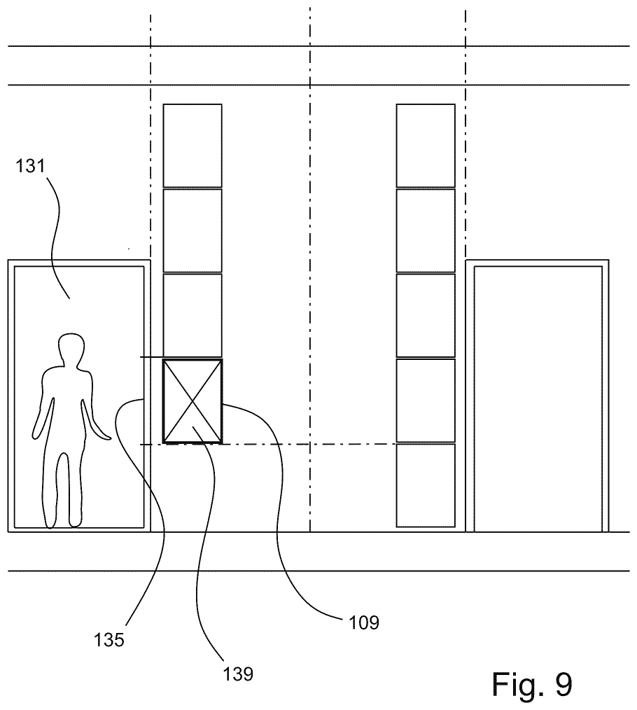

To illustrate this process, FIG. 9 shows a section through the changing area in accordance with FIGS. 7 and 8. FIG. 9 shows the opening 135 in the wall of a changing cubicle 131. If a storage box is placed by the manipulator (not shown in FIG. 9) at the storage area LP 139 located directly behind the opening 135, then the user of the changing cubicle 131 can, at the beginning of his visit, after changing, place his items of clothing and personal belongings in the storage box 107 that is located in the storage area 139. As soon as the user wants to leave the changing cubicle, he can give a signal that the storage box can be removed. This signal can also be generated automatically when the user leaves the changing cubicle 131.

Then the manipulator 101 moves with its effector 107 to the counter surface 111 of the storage box 109 located in the storage area 139, establishes the connection, and removes the storage box 109 from the storage area 139. He then places the storage box in any other storage area in the high-rack storage facility 137. Then the next user can enter the changing cubicle 131.

When this user has just entered the spa, an empty storage box 109 is placed in storage area 139 for him so that he can change.

If the next user wants to end the visit in the spa or the swimming pool or the working region, he can have the storage box 109 filled with his belongings, which is located at any storage area of the rack storage 137, brought to the storage area 139. Once there, the user opens the storage box 109, takes out his belongings therefrom and can get dressed again.

The same processes also take place analogously in the other changing cubicles which are numbered from 1 to 12 in FIG. 8.

This makes it possible for several hundred users to “share” twelve changing cubicles, wherein the users of course use the changing cubicles one after the other.

Each user is provided with an empty storage box 109 at the beginning of his/her visit, namely precisely in the storage area that is located behind the opening 135 in the changing cubicle of the user. The user can then change clothes and temporarily store his belongings in the storage box 109.

After leaving the changing cubicle, the storage box 109 is temporarily stored in the rack storage facility.

When the user has finished his visit, he enters any of the changing cubicles 1 to 12. The storage box filled with his belongings is then removed from the rack storage facility 135 and brought to the storage area located behind the opening 135 of the changing cubicle of the user.

The lane in which the manipulator moves is not accessible to the public; no one is present there during operation so that the manipulator 101 poses no danger to the public or employees.

### LIST OF REFERENCE SIGNS

101 Storage box manipulator
103 to 106 Rotary axes of the manipulator
107 Effector
109 Storage box
111 Counter surface
113 Flange plate
115 Plate
117 Spacer
119 Magnetic holding elements
121 Holding region
123 Holding surface of the effector
125 Contact pin (spring-loaded)
127 Rail
129 Base part
131 Changing cubicle
133 Changing cubicle door
135 Opening
137 Rack storage facility
138 Longitudinal axis
139 Storage area

1-10. (canceled)

11. A storage box manipulator for storage boxes comprising an effector, wherein the effector is detachably connectable to an interface of a storage box, wherein the effector comprises at least two switchable magnetic holding elements, wherein holding regions of the magnetic holding elements span a holding surface, wherein the interface of the storage box is a ferromagnetic counter surface, wherein the counter surface is shaped complementarily to the holding surface of the effector, and wherein the holding surface of the effector and the counter surface of the storage box are flat.

12. The storage box manipulator of claim 11, further comprising contact detection means for detecting contact between the holding surface or the holding regions of the effector and the counter surface of the storage box.

13. The storage box manipulator of claim 12, wherein the contact detection means comprises at least one spring-loaded contact pin, wherein the spring-loaded contact pin protrudes beyond the holding surface when there is no contact between the holding surface and the counter surface of the storage box, and wherein an end of the spring-loaded contact pin lies in the holding surface when there is contact between the holding surface of the effector and the counter surface of the storage box.

14. The storage box manipulator of claim 13, wherein the contact detection means comprises at least two spring-loaded contact pins, wherein an electrical voltage is applied between two of the contact pins, and wherein contact between the holding surface of the effector and the counter surface of the storage box is detected when an electrical current flows between the contact pins to which the electrical voltage is applied.

15. The storage box manipulator of claim 11, wherein each of the magnetic holding elements comprises one or more permanent magnets and at least one electromagnet, and wherein, when the electromagnet is energized, magnetic forces exerted by the one or more permanent magnets and the at least one electromagnet on the counter surface of the storage box cancel each other out by at least 60 percent.

16. The storage box manipulator of claim 11, wherein the manipulator is an articulated arm robot or an industrial robot.

17. The storage box manipulator of claim 11, wherein the manipulator is movable.

18. The storage box manipulator of claim 17, wherein the manipulator is configured to be moved on rails or on wheels.
